(19) United States
(12) Patent Application Publication
(10) Pub. No.: US 2012/0133279 A1
(43) Pub. Date: May 31, 2012

(54) ARC TUBE AND METHOD OF MANUFACTURING SAME

(75) Inventors: Sugio MIYAZAWA, Kasugai-city (JP); Keiichiro Watanabe, Kasugai-city (JP); Tsuneaki Ohashi, Nagoya-city (JP)

(73) Assignee: NGK Insulators, Ltd., Nagoya-City (JP)

(21) Appl. No.: 13/302,386

(22) Filed: Nov. 22, 2011

(30) Foreign Application Priority Data
Nov. 30, 2010 (JP) 2010-266658

(51) Int. Cl. H01J 61/36; H01J 61/06; H01R 43/00

(52) U.S. Cl. 313/623; 29/825

(57) ABSTRACT

An arc tube includes a light emitting body for light therein and a ceramic tube having a first capillary and a second capillary integral with respective opposite sides of the light emitting body. A first electrode is inserted and sealed in the first capillary, and a second electrode is inserted and sealed in the second capillary. The first electrode is sealed in the first capillary by shrink fitting.

### CROSS-REFERENCE TO RELATED APPLICATION

This application is based upon and claims the benefit of priority from Japanese Patent Application No. 2010-266658 filed on Nov. 30, 2010, of which the contents are incorporated herein by reference.

### BACKGROUND OF THE INVENTION

1. Field of the Invention

The present invention relates to an arc tube including a high-intensity discharge lamp such as a high-pressure sodium vapor lamp, a metal halide lamp, or the like, and a method of manufacturing such an arc tube, and more particularly to an arc tube having a ceramic tube which has a light emitting body for emitting light therein and a first capillary and a second capillary integral with respective opposite sides of the light emitting body, with a first electrode inserted and sealed in the first capillary and a second electrode inserted and sealed in the second capillary, and a method of manufacturing such an arc tube.

2. Description of the Related Art

Ceramic metal halide lamps produce light based on an electric discharge through a metal halide ionized by a pair of electrodes that are inserted in a ceramic tube for high-intensity discharge lamps.

The ceramic tube includes a pair of capillaries whose respective axes are oriented in facing relation to the light emitting body. The capillaries have respective electrode insertion holes defined therein, and electrodes are inserted respectively through the electrode insertion holes. There are available various types of ceramic tubes including a ceramic tube fabricated by assembling a plurality of components, a ceramic tube fabricated as a single unitary component, and a ceramic tube fabricated by joining two components.

The arc tube is assembled by inserting an electrode into the electrode insertion hole of one of the two capillaries of the ceramic tube, sealing the electrode with glass frit or the like, then introducing a light-emitting substance through the electrode insertion hole of the other capillary into a light-emitting receptacle, inserting an electrode into the electrode insertion hole of the other capillary, and finally sealing the electrode with glass frit or the like (see, for example, Japanese Laid-Open Patent Publication No. 2005-302624, Japanese Laid-Open Patent Publication No. 2010-177092, Japanese Laid-Open Patent Publication No. 2009-163973, and Japanese Laid-Open Patent Publication No. 2008-262728).

### SUMMARY OF THE INVENTION

The process according to the related art for assembling the arc tube is problematic in that it requires an increased number of assembling steps because the electrodes need to be sealed by glass frit. The arc tube according to the related art itself is disadvantageous for the following reasons: Since the two electrodes are inserted and sealed in the corresponding capillaries after the ceramic tube is fabricated, the inside diameter of each of the capillaries have to be larger than the maximum diameter of the electrodes, i.e., the diameter of their distal ends. In addition, the electrodes are positioned by bringing rod- or ring-shaped stops on the electrodes into contact with the ends of the ceramic tubes, i.e., the ends of the capillaries. Therefore, as the capillaries tend to have different lengths, the distal ends of the electrodes tend to project from inner surfaces of the light emitting body by different distances, resulting in an emission color variation and a reduction in the arc tube service life due to the different distances from the inner surface of the light emitting body. As the respective electrodes are positioned at the opposite ends of the ceramic tube, if the ceramic tube has a different overall length, the distance between the electrodes becomes different, resulting in a reduction in the efficiency of the arc tube and an emission color variation. When the electrodes are sealed in the electrodes, the electrodes are likely to be displaced out of position because of a clearance that is present between the capillaries and leads of the electrodes. Consequently, the electrodes are not constantly positioned with respect to the central axis of the arc tube, also resulting in an emission color variation.

Since the diameter of the distal ends of the electrodes cannot be greater than the inside diameter of the capillaries, the electrodes tend to be heated to a high temperature which is responsible for a reduction in the arc tube service life. If the inside diameter of the capillaries is increased, then the diameter of the distal ends of the electrodes can also be increased. However, the increased inside diameter of the capillaries results in an increase in the gap between the electrodes and the inner surfaces of the capillaries. As a result, the light-emitting substance tends to be trapped in the gap, and is apt to corrode the regions which seal the electrodes in the capillaries. As the amount of light-emitting substance in the light emitting body becomes unstable and the electrodes are not constantly positioned with respect to the central axis of the arc tube, the arc tube is likely to cause an emission color variation. If the diameter of the electrodes other than their distal ends is increased in a manner to be commensurate with the inside diameter of the capillaries, then thermal stresses due to the difference between the coefficients of thermal expansion of the electrode and the capillaries are increased, tending to cause the capillaries to crack. The thermal capacity of the electrodes is increased, reducing the efficiency of the arc tube.

It is an object of the present invention to provide an arc tube and a method of manufacturing an arc tube which make it possible to simplify a manufacturing process, reduce an emission color variation, improve an arc tube service life, increase lamp efficiency, and increase arc tube reliability.
[1] According to a first aspect of the present invention, there is provided an arc tube comprising a light emitting body for light therein, a ceramic tube having a first capillary and a second capillary integral with respective opposite sides of the light emitting body, a first electrode inserted and sealed in the first capillary, and a second electrode inserted and sealed in the second capillary, wherein the first electrode is sealed in the first capillary by shrink fitting.
[2] In the first aspect of the present invention, a portion of the first electrode which is shrink-fitted in the first capillary has a diameter in the range from 0.18 mm to 0.5 mm
[3] In the first aspect of the present invention, the first electrode includes a distal end portion having a diameter in the range from 0.22 mm to 2.0 mm, and in the range from 1.2 times to 4 times an inside diameter of the first capillary.
[4] In the first aspect of the present invention, the first electrode serves as a cathode electrode, the second electrode as an anode electrode, and a portion of the first electrode which is sealed in the first capillary has a diameter in the range from 0.2 times to 0.9 times a diameter of a portion of the second electrode which is sealed in the second capillary.
[5] In the first aspect of the present invention, the ceramic tube is constructed by assembling and sintering a first member integral with a first small hollow cylindrical portion which will subsequently become the first capillary, a second member integral with a second small hollow cylindrical portion which will subsequently become the second capillary, and the first electrode.
[6] In the first aspect of the present invention, the first electrode has a positioner for positioning a distal end position of the first electrode in the light emitting body by contacting an end of the first capillary.
[7] In the first aspect of the present invention, the first electrode has a positioner for positioning a distal end position of the first electrode in the light emitting body by contacting an inner surface of the first member which faces the light emitting body.
[8] In the first aspect of the present invention, the first member includes a hollow cylindrical portion having a hollow region therein with an opening defined in one end thereof, and the first small hollow cylindrical portion which is integral with a portion of the hollow cylindrical portion which is opposite to the opening, and the second member includes a plug closing the opening in the hollow cylindrical portion and the second small hollow cylindrical portion which is integral with a central portion of the plug.
[9] In the first aspect of the present invention, the second member includes a hollow cylindrical portion having a hollow region therein with an opening defined in one end thereof, and the second small hollow cylindrical portion which is integral with a portion of the hollow cylindrical portion which is opposite to the opening, and the first member includes a plug closing the opening in the hollow cylindrical portion and the first small hollow cylindrical portion which is integral with a central portion of the plug.
[10] In the first aspect of the present invention, the first member includes a first curved portion having a hollow region therein with a first opening defined in one end thereof, and the first small hollow cylindrical portion which is integral with a portion of the first curved portion which is opposite to the first opening, the second member includes a second curved portion having a hollow region therein with a second opening defined in one end thereof, and the second small hollow cylindrical portion which is integral with a portion of the second curved portion which is opposite to the second opening, and the ceramic tube is constructed by joining the first member and the second member such that the first opening and the second opening face each other.
[11] According to a second aspect of the present invention, there is also provided a method of manufacturing an arc tube including a light emitting body for light therein, a ceramic tube having a first capillary and a second capillary integral with respective opposite sides of the light emitting body, a first electrode inserted and sealed in the first capillary, and a second electrode inserted and sealed in the second capillary, comprising a first member fabricating step of pre-sintering a first ceramic compact into a first member having a first small hollow cylindrical portion which will subsequently become the first capillary and a first through hole defined axially in the first small hollow cylindrical portion, a second member fabricating step of pre-sintering a second ceramic compact into a second member having a second small hollow cylindrical portion which will subsequently become the second capillary and a second through hole defined axially in the second small hollow cylindrical portion, an assembling step of assembling the first member, the second member, and the first electrode into an assembled body, a ceramic tube fabricating step of sintering the assembled body into the ceramic tube having the light emitting body, the first capillary, and the second capillary, and sealing the first electrode in the first capillary by shrink fitting, a step of introducing a light-emitting substance through the second capillary into the light emitting body of the ceramic tube, and an electrode sealing step of inserting and sealing the second electrode in the second capillary.
[12] In the second aspect of the present invention, the first member fabricating step pre-sinters the first ceramic compact into the first member at a first temperature, the second member fabricating step pre-sinters the second ceramic compact into the second member at a second temperature which is higher than the first temperature, and the ceramic tube fabricating step sinters the assembled body into the ceramic tube at a third temperature which is higher than the second temperature.
[13] In the second aspect of the present invention, the first electrode includes a distal end portion having a diameter smaller than a diameter of the first through hole and a positioner on a rear end portion thereof for determining a distal end position of the first electrode, and in the assembling step, the second member and the first member are assembled such that the first member and the second member face each other, and thereafter the first electrode is inserted into the first through hole of the first member until the positioner contacts a rear end of the first small hollow cylindrical portion.
[14] In the second aspect of the present invention, the first member fabricating step pre-sinters the first ceramic compact into the first member at a fourth temperature, the second member fabricating step pre-sinters the second ceramic compact into the second member at a fifth temperature which is lower than the fourth temperature, and the ceramic tube fabricating step sinters the assembled body into the ceramic tube at a third temperature which is higher than the fourth temperature.
[15] In the second aspect of the present invention, the first electrode includes a distal end portion having a diameter larger than a diameter of the first through hole and a positioner on a distal end part thereof for determining a distal end position of the first electrode, and in the assembling step, the first electrode is inserted into the first through hole of the first member until the positioner contacts an end face which is to face the second member, and then the first member and the second member are assembled such that the first member and the second member face each other.

With the arc tube and the method of manufacturing same according to the present invention, since one of the electrodes is shrink-fitted, the process for assembling the arc tube is simplified. As the electrode is positioned using the inner surface of light emitting body, the distance that the electrode projects into the light emitting body is made constant, making constant the distance between the distal end of the electrode and the inner surface of the light emitting body. As the capillaries and electrode leads are held in close contact with each other, the electrodes are not displaced out of alignment with the central axis of the arc tube for thereby reducing an emission color variation and increasing lamp efficiency. Since the diameter of the distal end portion of the electrode can be increased, the service life of the arc tube is increased. Furthermore, since the shrink-fitted portion of the electrode can be made thin, the arc tube is prevented from cracking under thermal stresses.

According to the present invention, therefore, the arc tube and the method of manufacturing same make it possible to simplify a manufacturing process, reduce an emission color variation, improve an arc tube service life, increase lamp efficiency, and increase arc tube reliability.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a cross-sectional view of an arc tube (first arc tube) according to a first embodiment of the present invention;

FIG. 2A is a cross-sectional view showing a process step for successively assembling a second ceramic pre-sintered compact, a first ceramic pre-sintered compact, and a first electrode into a first assembled body;

FIG. 2B is a cross-sectional view showing the first assembled body sintered into a first ceramic tube;

FIG. 3 is a flowchart of a first manufacturing method for fabricating a first arc tube;

FIG. 4A is a cross-sectional view of a first ceramic compact (or a second ceramic compact);

FIG. 4B is a cross-sectional view of a second ceramic compact (or a first ceramic compact);

FIG. 5 is a cross-sectional view of an arc tube (second arc tube) according to a second embodiment of the present invention;

FIG. 6A is a cross-sectional view showing a process step for successively assembling a first ceramic pre-sintered compact, a first electrode, and a second ceramic pre-sintered compact into a second assembled body;

FIG. 6B is a cross-sectional view showing the second assembled body sintered into a second ceramic tube;

FIG. 7 is a flowchart of a second manufacturing method for fabricating a second arc tube;

FIG. 8 is a cross-sectional view, partly omitted from illustration, of an arc tube (third arc tube) according to a third embodiment of the present invention;

FIG. 9A is a cross-sectional view of a first ceramic pre-sintered compact and a second ceramic pre-sintered compact which are components of an arc tube (fourth arc tube) according to a fourth embodiment of the present invention;

FIG. 9B is a cross-sectional view of a fourth arc tube;

FIG. 10A is a cross-sectional view of a first ceramic pre-sintered compact and a second ceramic pre-sintered compact which are components of an arc tube (fifth arc tube) according to a fifth embodiment of the present invention; and

FIG. 10B is a cross-sectional view of a fifth arc tube.

### DESCRIPTION OF THE PREFERRED EMBODIMENTS

Like or corresponding parts are denoted by like or corresponding reference characters throughout views.

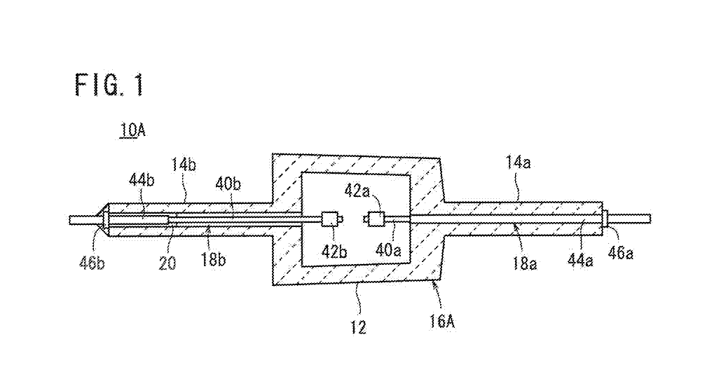

Arc tubes and methods of manufacturing same according to preferred embodiments of the present invention will be described below with reference to FIGS. 1 through 10B. Numerical ranges which will be referred to in the present description represent a range from a lower limit value to an upper limit value, inclusive of those lower and upper limit values.

The arc tubes include high-pressure lamps that are suitable for use in various illuminating devices for road illuminating devices, shop illuminating devices, automobile headlamps, liquid crystal projectors, etc. The arc tubes also include arc tubes for metal halide lamps and high-pressure sodium vapor lamps.

As shown in FIG. 1, an arc tube (hereinafter referred to as “first arc tube 10A”) according to a first embodiment of the present invention includes a hollow cylindrical light emitting body 12 for emitting light therein and a first ceramic tube 16A having a first capillary 14a and a second capillary 14b, each in the form of a hollow cylinder, integral with respective opposite sides of the light emitting body 12. In the first ceramic tube 16A, a first electrode 18a is inserted and sealed in the first capillary 14a and a second electrode 18b is inserted and sealed in the second capillary 14b. In the first arc tube 10A, the first electrode 18a is sealed in the first capillary 14a by shrink fitting. The second electrode 18b is sealed in the second capillary 14b by a sealant 20 such as of frit glass or the like.

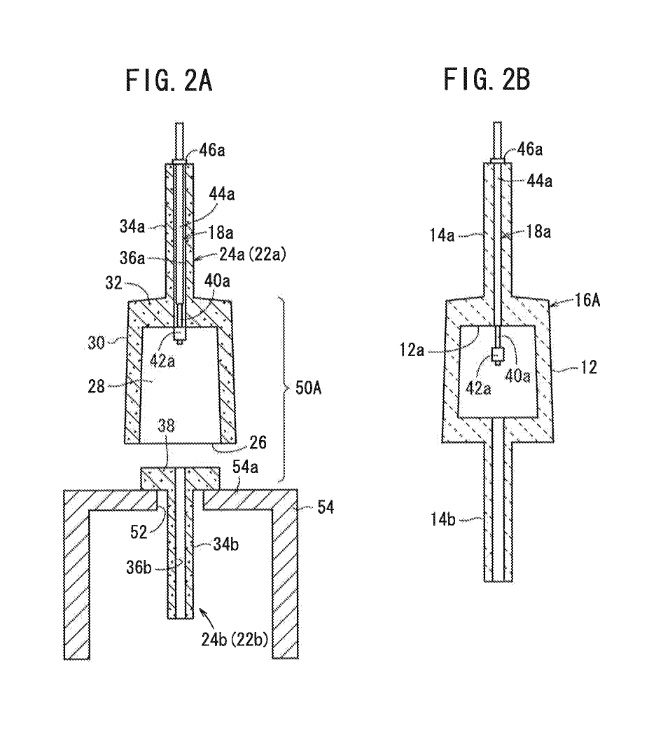

As shown in FIGS. 2A and 2B, the first ceramic tube 16A is fabricated by joining a first ceramic pre-sintered compact 24a, which is produced by pre-sintering a first ceramic compact 22a, and a second ceramic pre-sintered compact 24b, which is produced by pre-sintering a second ceramic compact 22b, to each other, and then sintering the first ceramic pre-sintered compact 24a and the second ceramic pre-sintered compact 24b which are joined to each other.

As shown in FIG. 2A, the first ceramic pre-sintered compact 24a has a large hollow cylindrical portion 30 having a hollow region 28 therein with an opening 26 defined in one end thereof, a first small hollow cylindrical portion 34a (which will subsequently become the first capillary 14a) integral with an end (bottom 32) of the large hollow cylindrical portion 30 which is opposite to the opening 26, and a first through hole 36a extending from an end of the first small hollow cylindrical portion 34a to an inner surface of the large hollow cylindrical portion 30. The second ceramic pre-sintered compact 24b has a plug 38 in the form of a disk which closes the opening 26 in the large hollow cylindrical portion 30 of the first ceramic pre-sintered compact 24a, the plug 38 having a flat end face, a second small hollow cylindrical portion 34b (which will subsequently become the second capillary 14b) integral with a central area of the plug 38, and a second through hole 36b extending from an end of the second small hollow cylindrical portion 34b to the end face of the plug 38. The bottom 32 of the large hollow cylindrical portion 30 of the first ceramic pre-sintered compact 24a has a flat inner surface which faces the hollow region 28 in confronting relation to the end face of the plug 38.

As shown in FIG. 1, the first electrode 18a has a first electrode shank 40a, a first coil 42a wound around a distal end portion of the first electrode shank 40a, and a first lead 44a connected to a rear end of the first electrode shank 40a. A first stop 46a in the form of a rod or a ring is fixedly mounted on the first lead 44a. The first stop 46a is held in contact with the end of the first capillary 14a (first small hollow cylindrical portion 34a) to determine the distal end position of the first electrode 18a in the light emitting body 12. The first coil 42a has a maximum diameter which essentially serves as the diameter of the distal end portion of the first electrode 18a, and the distal end of the first electrode shank 40a which projects from the distal end position of the first coil 42a serves as the distal end position of the first electrode 18a.

The diameter of the distal end portion of the first electrode 18a is slightly smaller than the inside diameter of the first through hole 36a in the first ceramic pre-sintered compact 24a, and is in the range from 1.2 times to 4 times the inside diameter of the first capillary 14a. Preferably, the diameter of the distal end portion of the first electrode 18a should be in the range from 0.22 mm to 2.0 mm. The portion of the first electrode 18a which is shrink-fitted in the first capillary 14a, i.e., the first lead 44a, has a diameter in the range from 0.18 mm to 0.5 mm, which is slightly greater than the inside diameter of the first capillary 14a, so that a compressive force due to sintering shrinkage will be applied to the boundary between the first lead 44a and the first capillary 14a. The diameter of the first lead 44a is smaller than the diameter of the distal end portion of the first electrode 18a. The first stop 46a has a length or outside diameter greater than the inside diameter of the first through hole 36a and smaller than the outside diameter of the first capillary 14a.

The second electrode 18b has a second electrode shank 40b, a second coil 42b wound around a distal end portion of the second electrode shank 40b, and a second lead 44b connected to a rear end of the second electrode shank 40b and having a diameter greater than the diameter of the second electrode shank 40b. A second stop 46b in the form of a ring is fixedly mounted on the second lead 44b. The second stop 46b is held in contact with the end of the second capillary 14b to determine the distal end position of the second electrode 18b in the light emitting body 12. The second coil 42b has a maximum diameter which essentially serves as the diameter of the distal end portion of the second electrode 18b, and the distal end of the second electrode shank 40b which projects from the second coil 42b serves as the distal end of the second electrode 18b.

The diameter of the distal end portion of the second electrode 18b is slightly smaller than the inside diameter of the second capillary 14b, and the diameter of the second electrode shank 40b is smaller than the diameter of the second lead 44b. The outside diameter of the second stop 46b is greater than the inside diameter of the second capillary 14b and smaller than the outside diameter of the second capillary 14b. The inside diameter of the second capillary 14b is greater than the inside diameter of the first capillary 14a.

The first arc tube 10A can be used with an AC power system or a DC power system. If the first arc tube 10A is used with the DC power system, then since the temperature of the cathode electrode is lower than the temperature of the anode electrode, a light-emitting substance in the light emitting body tends to find its way into the minute gap in the sealed portion of the cathode electrode. As the light-emitting substance that has been trapped in the minute gap is liquefied and solidified and cannot go back to the light emitting body, the fluxes of light emitted by the light emitting body is likely to decrease. To avoid such trouble, the first electrode 18a with no gap defined between itself and the first capillary 14a of the first ceramic tube 16A should preferably serves as the cathode electrode. Furthermore, if the temperature difference between the anode electrode and the cathode electrode is large, then it will cause an emission color variation. Consequently, in order to achieve a state of temperature balance, it is preferable to use the first electrode 18a as the cathode electrode, to use the second electrode 18b as the anode electrode, and to keep the diameter of the first lead 44a within the range from 0.2 times to 0.9 times the diameter of the second lead 44b.

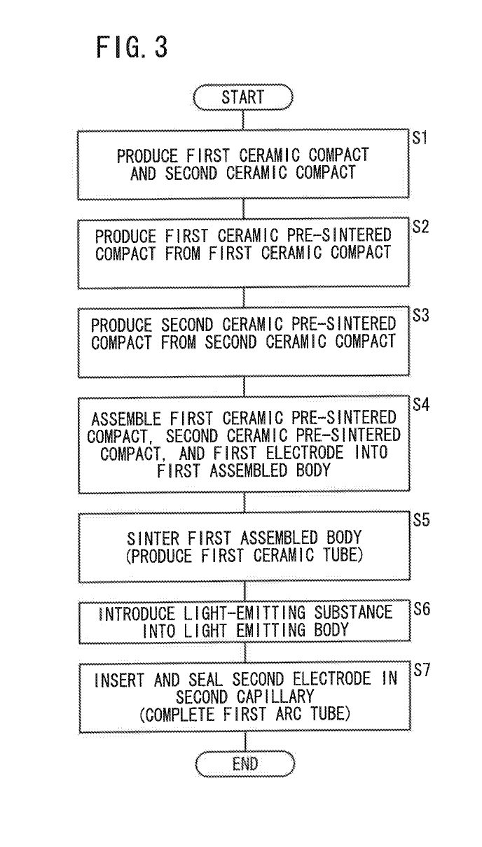

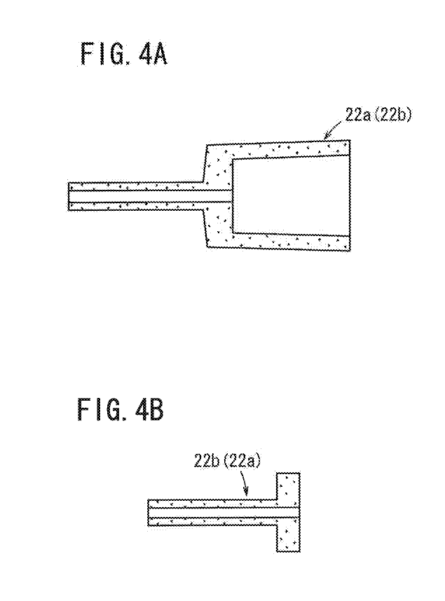

A manufacturing method (first manufacturing method) for fabricating the first arc tube 10A will be described below also with reference to FIGS. 3, 4A, and 4B.

In step Si shown in FIG. 3, as shown in FIGS. 4A and 4B, the first ceramic compact 22a and the second ceramic compact 22b are produced. Specifically, a ceramic powder, a dispersion medium, a gellant, etc. are mixed into a gel cast slurry (hereinafter referred to as “forming slurry”). The forming slurry is cast into a first casting mold for forming the first ceramic compact 22a and a second casting mold for forming the second ceramic compact 22b, and then is solidified. Thereafter, the first casting mold and the second casting mold are separated from each other, producing the first ceramic compact 22a and the second ceramic compact 22b.

In step S2, the first ceramic compact 22a is pre-sintered at a first temperature to produce the first ceramic pre-sintered compact 24a shown in FIG. 2A. The first temperature may be a temperature at which the level of densification of the first ceramic compact 22a is low, e.g., a temperature in the range from 700° C. to 1200° C. If the first temperature is too low, then the first ceramic pre-sintered compact 24a suffers a lack of mechanical strength and tends to be broken when assembled. Since the first ceramic compact 22a is generally pre-sintered in the atmosphere, if the pre-sintering temperature is too high, then it will be difficult to densify the first ceramic pre-sintered compact 24a in a subsequent sintering process. Therefore, it is desirable to pre-sinter the first ceramic compact 22a in the above temperature range.

Thereafter, in step S3, the second ceramic compact 22b is pre-sintered at a second temperature to produce the second ceramic pre-sintered compact 24b shown in FIG. 2A. The second temperature may be a temperature at which the level of densification of the second ceramic compact 22b is higher than the level of densification of the first ceramic compact 22a, e.g., a temperature which is higher than the first temperature by the range from 50° C. to 300° C. If the difference between the first temperature and the second temperature is too small, then the dimensional differences between the first ceramic pre-sintered compact 24a and the second ceramic pre-sintered compact 24b is too small to provide a sufficient clearance therebetween, tending to cause them to scar and crack. If the temperature difference is too large, then the dimensional differences become too large, causing the first ceramic pre-sintered compact 24a and the second ceramic pre-sintered compact 24b to shrink greatly until they are fixed to each other, and to tend to be skewed with respect to each other. Therefore, it is desirable to pre-sinter the second ceramic compact 22b in the above temperature range.

Then, in step S4, as shown in FIG. 2A, the first ceramic pre-sintered compact 24a, the second ceramic pre-sintered compact 24b, and the first electrode 18a are assembled into a first assembled body 50A. At this time, the plug 38 of the second ceramic pre-sintered compact 24b is inserted into the opening 26 of the first ceramic pre-sintered compact 24a to close the opening 26, and the first electrode 18a is inserted into the first through hole 36a of the first ceramic pre-sintered compact 24a.

Specifically, a jig 54 having a through hole 52 defined therein which is large enough for the second small hollow cylindrical portion 34b of the second ceramic pre-sintered compact 24b to pass therethrough is used, and the second small hollow cylindrical portion 34b is inserted through the through hole 52. The plug 38 of the second ceramic pre-sintered compact 24b is placed on an upper surface 54a of the jig 54, and then the first ceramic pre-sintered compact 24a is placed, from above, on the jig 54 such that the large hollow cylindrical portion 30 of the first ceramic pre-sintered compact 24a covers the plug 38. In this manner, the plug 38 is inserted into the opening 26 to close the opening 26. Thereafter, the first electrode 18a is inserted into the first through hole 36a from the rear end of the first small hollow cylindrical portion 34a of the first ceramic pre-sintered compact 24a. At this time, the first electrode 18a is inserted into the first through hole 36a until the first stop 46a abuts against the rear end of the first small hollow cylindrical portion 34a, whereupon the first assembled body 50A is completed.

Thereafter, in step S5, the first assembled body 50A which is placed on the jig 54 is sintered at a third temperature to produce a sintered body. Since the outside diameter of the plug 38 of the second ceramic pre-sintered compact 24b after it is sintered alone is adjusted to be 1% to 9% greater than the inside of the opening 26 of the first ceramic pre-sintered compact 24a after it is sintered, a compressive force due to sintering shrinkage will be applied to the boundary between the plug 38 and the surface of the first ceramic pre-sintered compact 24a which defines the opening 26. In addition, since the diameter of the first lead 44a of the first electrode 18a is adjusted to be slightly greater than the inside diameter of the first capillary 14a, a compressive force due to sintering shrinkage will be applied to the boundary between the first lead 44a and the first capillary 14a. Because of these compressive forces, as shown in FIG. 2B, the light emitting body 12, the first capillary 14a, and the second capillary 14b are integrated, producing the first ceramic tube 16A wherein the first electrode 18a is sealed in the first capillary 14a by shrink fitting. The third temperature may be a temperature for making the first assembled body 50A densified and light-permeable, e.g., a temperature in the range from 1700° C. to 1900° C. When the first assembled body 50A is sintered, the inside diameter of the first through hole 36a of the first ceramic pre-sintered compact 24a is reduced about 20% to 40%, for example, thereby sealing the first electrode 18a inserted in the first through hole 36a by shrink fitting. As a result, the diameter of the distal end portion of the first electrode 18a becomes greater than the inside diameter of the first capillary 14a.

When the first assembled body 50A is sintered, it is shrunk as a whole. Mainly, the first ceramic pre-sintered compact 24a is shrunk to a large extent, with its length being shorter along the axis of the first small hollow cylindrical portion 34a (first capillary 14a). As a consequence, the distal end part of the first electrode 18a is spaced from an inner surface 12a (ceramic wall surface) of the light emitting body 12 close to the first capillary 14a, making the distance from the inner surface 12a to the distal end position of the first electrode 18a greater than the axial length of a distal end part (first coil 42a) of the first electrode 18a. Since the distance varies depending on the amount of sintering shrinkage, i.e., the relative density of the compact. If a number of first ceramic tubes 16A are fabricated, then the above distance is made substantially constant between the first ceramic tubes 16A by making the relative density of the compacts constant.

Thereafter, in step S6, the light-emitting substance is introduced through the second capillary 14b into the light emitting body 12 of the first ceramic tube 16A. Specifically, in addition to an inactive start gas such as argon or the like, mercury and a metal halide additive are introduced into the light emitting body 12. Mercury may not necessarily be introduced.

In step S7, the second electrode 18b is inserted and sealed in the second capillary 14b. Specifically, as shown in FIG. 1, the second electrode 18b and the sealant 20 are inserted into the second capillary 14b, so that the second electrode 18b will be sealed in the second capillary 14b. At this time, the second electrode 18b is inserted until the second stop 46b abuts against the rear end of the second capillary 14b. Thereafter, the sealant 20 is applied to cover the second stop 46b, hermetically sealing the second electrode 18b. The first arc tube 10A is now completed.

With the first arc tube 10A and the first manufacturing method described above, since the first electrode 18a is sealed in the first capillary 14a of the first ceramic tube 16A by shrink fitting when the first assembled body 50A is sintered, the first electrode 18a does not need to be sealed in the first capillary 14a by the sealant 20. Therefore, the process of assembling the first arc tube 10A is simplified. If a plurality of first ceramic tubes 16A are fabricated, then the distal end position of the first electrode 18a is made substantially constant between the first ceramic tubes 16A by making the relative density of the compacts constant. Inasmuch as the first capillary 14a and the first lead 44a are held in close contact with each other, the position of the first electrode 18a is constant with respect to the central axis of the first arc tube 10A, leading to a reduction in the emission color variation and an increase in the lamp efficiency. As the diameter of the distal end portion of the first electrode 18a, i.e., the diameter of the first coil 42a, can be made greater than the inside diameter of the first capillary 14a, the cooling effect of the first coil 42a can be continued for a long period of time, improving the service life of the first arc tube 10A. Particularly, if the first arc tube 10A is used with a DC power system, then its service life is determined by the service life of the cathode electrode. The service life of the first arc tube 10A can be elongated by using the first electrode 18a as the cathode electrode. The inside diameter of the first capillary 14a can be reduced without being governed by the diameter of the distal end portion of the first electrode 18a. Since the diameters of the first electrode shank 40a and the first lead 44a which are held in contact with the first capillary 14a can thus be reduced, a thermal stress due to the difference between the coefficients of thermal expansion of the first capillary 14a and the first electrode 18a are prevented from increasing, thereby preventing the first arc tube 10A from cracking. Inasmuch as the diameters of the first electrode shank 40a and the first lead 44a can be reduced, the thermal capacity of the first electrode 18a is reduced, thereby preventing the lamp efficiency from being lowered by the first electrode 18a.

Therefore, the first arc tube 10A and the first manufacturing method make it possible to simplify a manufacturing process, reduce an emission color variation, improve an arc tube service life, increase lamp efficiency, and increase arc tube reliability.

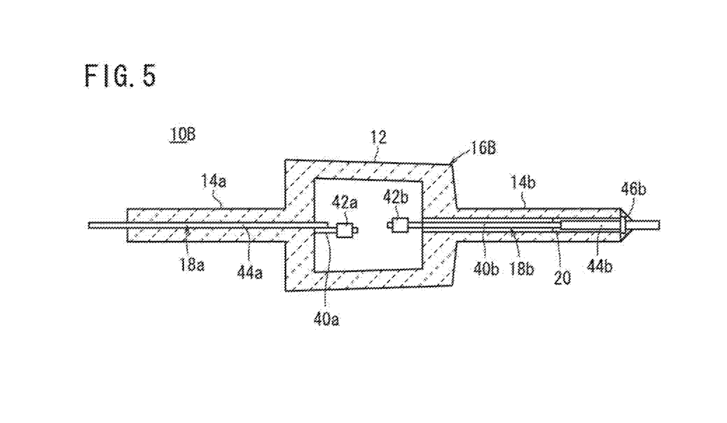

An arc tube (hereinafter referred to as “second arc tube 10B”) according to a second embodiment of the present invention will be described below with reference to FIGS. 5 through 7.

As shown in FIG. 5, the second arc tube 10B is substantially the same as the first arc tube 10A in that it has a second ceramic tube 16B wherein the light emitting body 12, the first capillary 14a, and the second capillary 14b are integral with each other and the first electrode 18a is sealed in the first capillary 14a by shrink fitting, but is different from the first arc tube 10A as described below. The second electrode 18b is sealed in the second capillary 14b by the sealant 20 such as grit glass or the like.

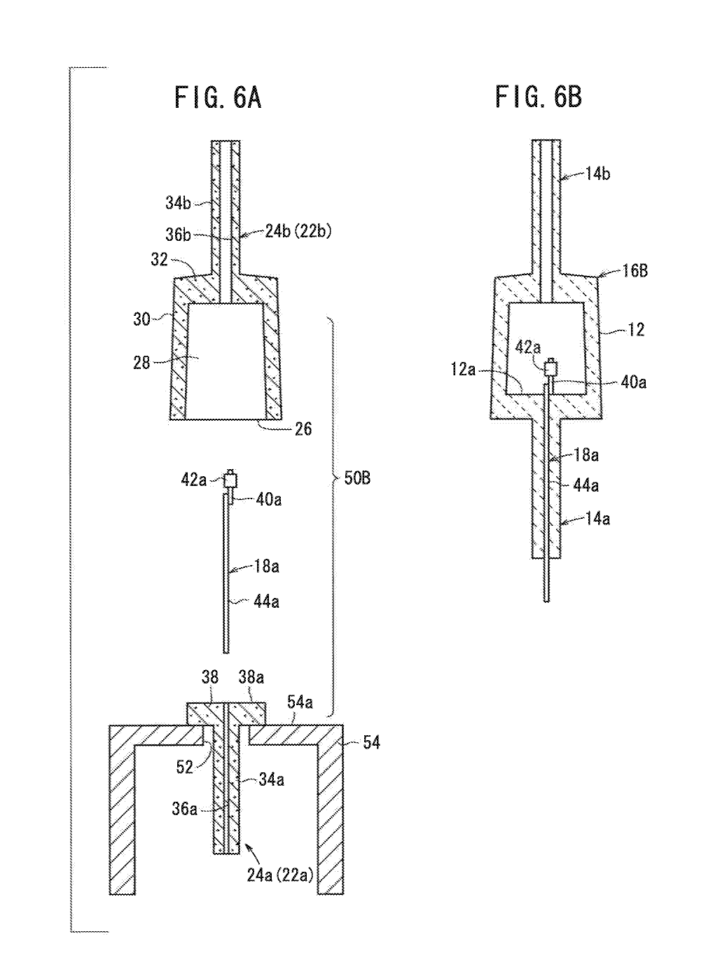

As shown in FIGS. 6A and 6B, the first ceramic pre-sintered compact 24a and the second ceramic pre-sintered compact 24b are a reversal of those of the first arc tube 10A. Specifically, the second ceramic pre-sintered compact 24b has a large hollow cylindrical portion 30 having a hollow region 28 therein with an opening 26 defined in one end thereof, a second small hollow cylindrical portion 34b integral with the bottom 32 of the large hollow cylindrical portion 30 which is opposite to the opening 26, and a second through hole 36b extending from an end of the second small hollow cylindrical portion 34b to the inner surface of the large hollow cylindrical portion 30. The first ceramic pre-sintered compact 24a has a plug 38 in the form of a disk which closes the opening 26 in the large hollow cylindrical portion 30 of the second ceramic pre-sintered compact 24b, the plug 38 having a flat end face 38a, a first small hollow cylindrical portion 34a integral with a central area of the plug 38, and a first through hole 36a extending from an end of the first small hollow cylindrical portion 34a to the end face 38a of the plug 38.

The first electrode 18a has a first electrode shank 40a, a first coil 42a wound around a distal end portion of the first electrode shank 40a, and a first lead 44a fixed to a side surface of the first electrode shank 40a. The first lead 44a is inserted into the first through hole 36a of the first ceramic pre-sintered compact 24a toward the rear end of the first small hollow cylindrical portion 34a to bring the rear end of the first electrode shank 40a into abutment against the end face 38a of the plug 38. The axial length of the first electrode shank 40a is made constant between a plurality of second arc tubes 10B to allow the rear end of the first electrode shank 40a to function as a positioner for positioning the distal end position of the first electrode 18a.

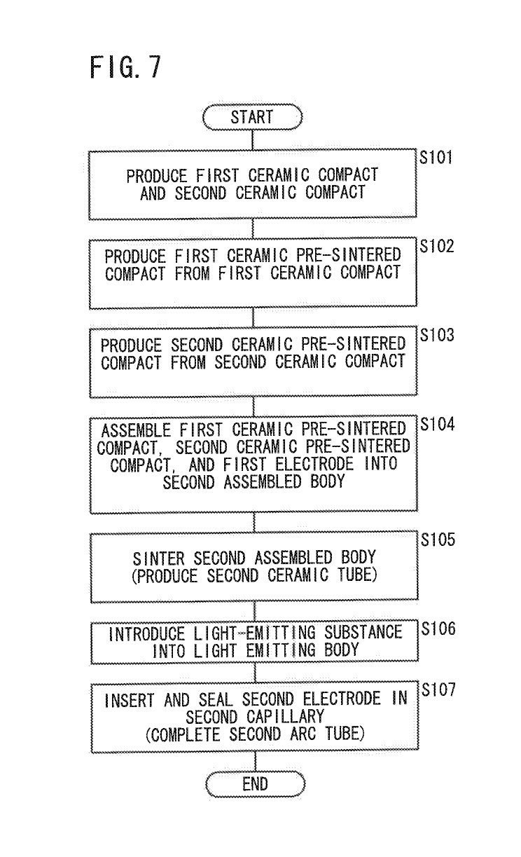

A manufacturing method (second manufacturing method) for fabricating the second arc tube 10B will be described below also with reference to FIG. 7.

In step S101 shown in FIG. 7, as shown in FIGS. 4A and 4B, the first ceramic compact 22a and the second ceramic compact 22b are produced. In FIGS. 4A and 4B, the reference characters in parentheses should be referred to as representing the first ceramic compact 22a and the second ceramic compact 22b. Specifically, a ceramic powder, a dispersion medium, a gellant, etc. are mixed into a forming slurry. The forming slurry is cast into a first casting mold and a second casting mold, and then is solidified. Thereafter, the first casting mold and the second casting mold are separated from each other, producing the first ceramic compact 22a and the second ceramic compact 22b.

In step S102, the first ceramic compact 22a is pre-sintered at a fourth temperature, which may be 1200° C., for example, or the second temperature referred to above, to produce the first ceramic pre-sintered compact 24a. In step S103, the second ceramic compact 22b is pre-sintered at a fifth temperature, which may be 1000° C., for example, or the first temperature referred to above, lower than the fourth temperature to produce the second ceramic pre-sintered compact 24b.

Then, in step S104, as shown in FIG. 6A, the first ceramic pre-sintered compact 24a, the second ceramic pre-sintered compact 24b, and the first electrode 18a are assembled into a second assembled body 50B. At this time, the first electrode 18a is inserted into the first through hole 36a of the first ceramic pre-sintered compact 24a, and the first ceramic pre-sintered compact 24a is inserted into the opening 26 of the second ceramic pre-sintered compact 24b to close the opening 26, producing the second assembled body 50B.

Specifically, a jig 54 having a through hole 52 defined therein which is large enough for the first small hollow cylindrical portion 34a of the first ceramic pre-sintered compact 24a to pass therethrough is used, and the first small hollow cylindrical portion 34a is inserted through the through hole 52. The plug 38 of the first ceramic pre-sintered compact 24a is placed on an upper surface 54a of the jig 54. Thereafter, the first electrode 18a is inserted into the first through hole 36a toward the rear end of the first small hollow cylindrical portion 34a until the rear end of the first electrode shank 40a contacts the end face of the first ceramic pre-sintered compact 24a, i.e., the end face 38a of the plug 38, whereupon the first electrode 18 is positioned. The second ceramic pre-sintered compact 24b is placed, from above, on the jig 54 such that the large hollow cylindrical portion 30 of the second ceramic pre-sintered compact 24b covers the plug 38. The first ceramic pre-sintered compact 24a is now inserted in the opening 26 of the second ceramic pre-sintered compact 24b to close the opening 26, whereupon the second assembled body 50B is completed.

Thereafter, in step S105, the second assembled body 50B which is placed on the jig 54 is sintered at a third temperature to produce a sintered body. The third temperature serves the purpose of making the second assembled body 50B densified and light-permeable. Specifically, the light emitting body 12, the first capillary 14a, and the second capillary 14b are integrated, producing the second ceramic tube 16B wherein the first electrode 18a is sealed in the first capillary 14a by shrink fitting. At this time, the second assembled body 50B is shrunk as a whole, with the second ceramic pre-sintered compact 24b being shrunk to a greater degree than the first ceramic pre-sintered compact 24a. Since the first stop 46a shown in FIG. 2B is not fixed to the first lead 44a, the rear end of the first electrode shank 40a remains in abutment against the end face 38a of the plug 38 of the first ceramic pre-sintered compact 24a, and is held against an inner surface 12a (ceramic wall surface) of the light emitting body 12 close to the first capillary 14a. In other words, the distal end of the first electrode 18a remains positioned by the rear end of the first electrode shank 40a. Even if the relative density of the compacts of a plurality of second ceramic tubes 16B suffers variations, since the distance from the distal end of the first electrode 18a to the positioner is small, the second ceramic tube 16B shrinks to a small degree and does not tend to be adversely affected by its shrinkage unlike the first ceramic tube 16A. Therefore, the distal end position of the first electrode 18a is stabilized. Inasmuch as the first capillary 14a and the first lead 44a are held in close contact with each other, the position of the first electrode 18a is constant with respect to the central axis of the second arc tube 10B.

Thereafter, in step S106, the light-emitting substance is introduced through the second capillary 14b into the light emitting body 12 of the second ceramic tube 16B. In step S107, the second electrode 18b is inserted and sealed in the second capillary 14b by the sealant 20. The second arc tube 10B is now completed.

With the second arc tube 10B and the second manufacturing method therefor described above, the manufacturing process is simplified, the emission color variation is reduced, the arc tube service life is increased, the lamp efficiency is increased, and the arc tube reliability is increased, as with the first arc tube 10A. In particular, since the first electrode 18a of the second arc tube 10B is positioned using the inner surface of the first ceramic pre-sintered compact 24a, i.e., the end face 38a of the plug 38, the distance between the distal end of the first electrode 18a and the inner surface of the second arc tube 10B is made constant, thereby reducing the emission color variation and increasing the lamp efficiency.

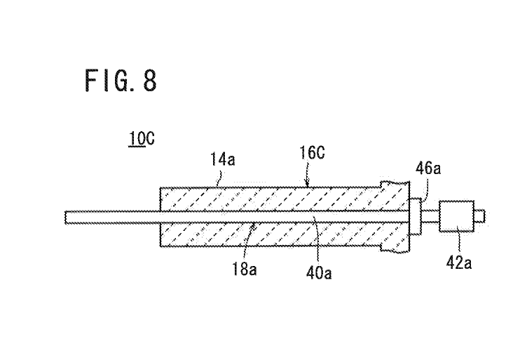

An arc tube (hereinafter referred to as “third arc tube 10C”) according to a third embodiment of the present invention will be described below with reference to FIG. 8.

As shown partly in FIG. 8, the third arc tube 10C has a third ceramic tube 16C which is substantially the same as the corresponding tube of the second arc tube 10B described above, but is different from the second arc tube 10B as to the structure of the first electrode 18a as follows:

The first electrode 18a includes a first electrode shank 40a having an axial length greater than the axial length of the first capillary 14a and a first stop 46a in the form of a rod or a ring fixed to a portion of the first electrode shank 40a near a first coil 42a and having a length or outside diameter greater than the inside diameter of the first through hole 36a (see FIG. 6A) in the first ceramic pre-sintered compact 24a.

In the process of fabricating the third arc tube 10C, the first electrode shank 40a is inserted into the first through hole 36a in the first ceramic pre-sintered compact 24a toward the rear end of the first small hollow cylindrical portion 34a until the rear end of the first stop 46a abuts against the end face of the first ceramic pre-sintered compact 24a, i.e., the end face 38a of the plug 38. The fixed position of the first stop 46a is made constant between a plurality of third arc tubes 10C to allow the rear end of the first stop 46a to function as a positioner for positioning the distal end position of the first electrode 18a.

The third arc tube 10C can be fabricated by the second manufacturing method shown in FIG. 7 for fabricating the second arc tube 10B. The third arc tube 10C offers the same advantages as the second arc tube 10B described above. In particular, as the axis of the first electrode 18a and the axis of the second electrode 18b are substantially held in alignment with each other, the light emission efficiency is further increased. In the above description, the first electrode shank 40a is shrink-fitted in the first capillary 14a, However, if the first lead 44a is coupled, preferably coaxially, to the rear end of the first electrode shank 40a, and is shrink-fitted in the first capillary 14a, then the diameter of the first electrode shank 40a and the diameter of the shrink-fitted portion can freely be selected, respectively.

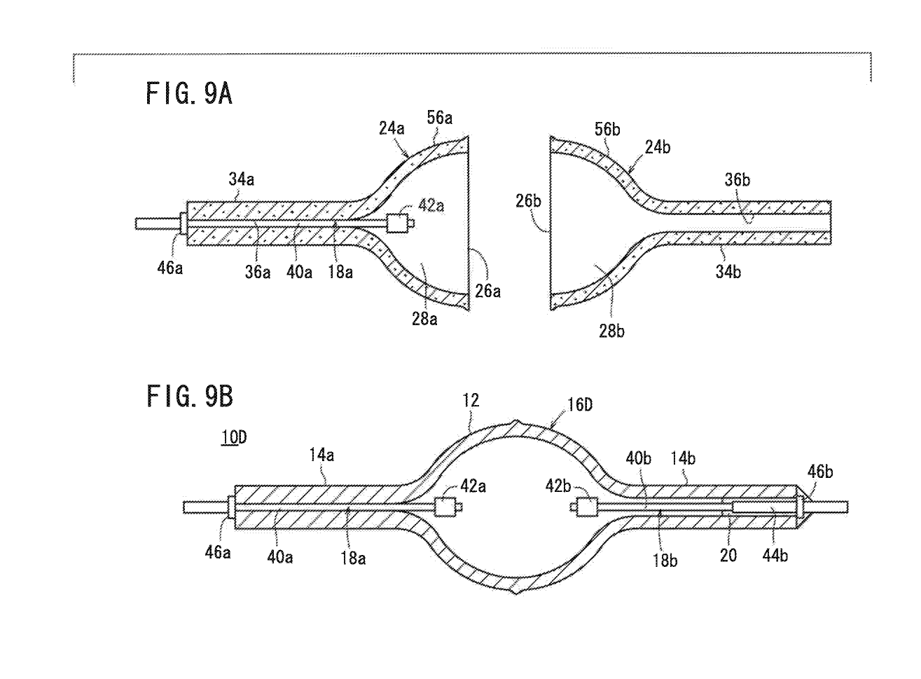

An arc tube (hereinafter referred to as “fourth arc tube 10D”) according to a fourth embodiment of the present invention will be described below with reference to FIGS. 9A and 9B.

As shown in FIGS. 9A and 9B, the fourth arc tube 10D is substantially the same as the first arc tube 10A in that it has a fourth ceramic tube 16D wherein the light emitting body 12, the first capillary 14a, and the second capillary 14b are integral with each other and the first electrode 18a is sealed in the first capillary 14a by shrink fitting, but is different from the first arc tube 10A as described below. The second electrode 18b is sealed in the second capillary 14b by the sealant 20 such as grit glass or the like.

As shown in FIG. 9A, the first ceramic pre-sintered compact 24a includes a first curved portion 56a having a first opening 26a defined in one end thereof and also having a first hollow region 28a therein, a first small hollow cylindrical portion 34a integral with a portion of the first curved portion 56a which is opposite to the first opening 26a, and a first through hole 36a extending from an end of the first small hollow cylindrical portion 34a to an inner surface of the first curved portion 56a.

The second ceramic pre-sintered compact 24b includes a second curved portion 56b having a second opening 26b defined in one end thereof and also having a second hollow region 28b therein, a second small hollow cylindrical portion 34b integral with a portion of the second curved portion 56b which is opposite to the second opening 26b, and a second through hole 36b extending from an end of the second small hollow cylindrical portion 34b to an inner surface of the second curved portion 56b.

The first electrode 18a includes a first electrode shank 40a having an axial length greater than the axial length of the first through hole 36a, and a first coil 42a wound around a distal end portion of the first electrode shank 40a. A first stop 46a in the form of a ring is integral with the first electrode shank 40a. The first stop 46a is held in contact with the end of the first small hollow cylindrical portion 34a to determine the distal end position of the first electrode 18a in the light emitting body 12.

The fourth arc tube 10D can be fabricated by the first manufacturing method shown in FIG. 3 for fabricating the first arc tube 10A. The end face of the first ceramic pre-sintered compact 24a where the first opening 26a is defined, and the end face of the second ceramic pre-sintered compact 24b where the second opening 26b is defined are joined to each other by a joining slurry. The fourth arc tube 10D offers the same advantages as the first arc tube 10A described above.

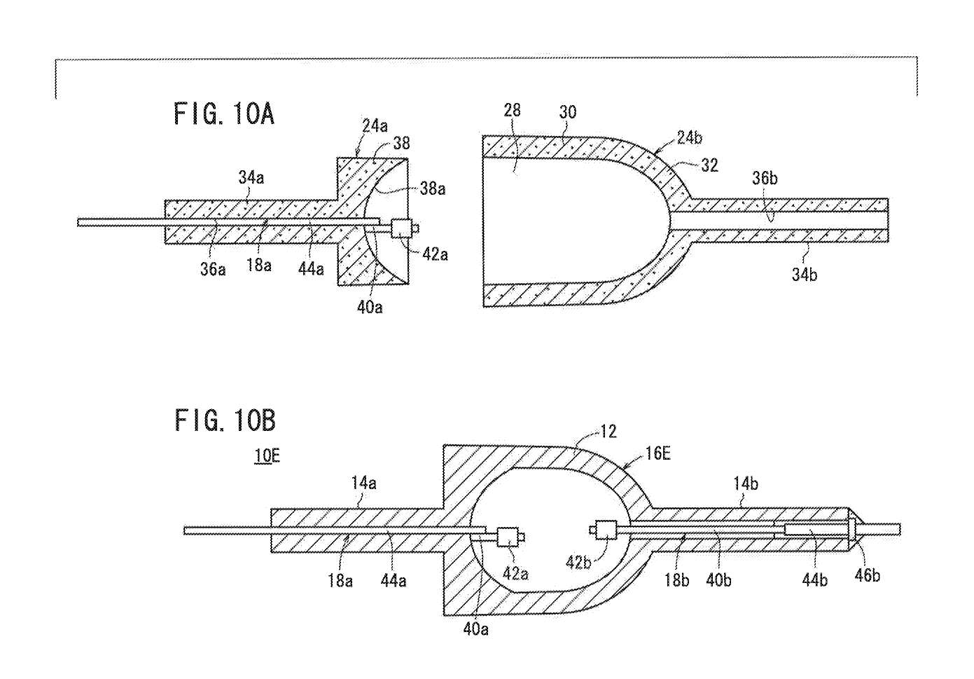

An arc tube (hereinafter referred to as “fifth arc tube 10E”) according to a fifth embodiment of the present invention will be described below with reference to FIGS. 10A and 10B.

As shown in FIGS. 10A and 10B, the fifth arc tube 10E is substantially the same as the second arc tube 10B in that it has a fifth ceramic tube 16E wherein the light emitting body 12, the first capillary 14a, and the second capillary 14b are integral together and the first electrode 18a is sealed in the first capillary 14a by shrink fitting, but is different from the second arc tube 10B as described below. The second electrode 18b is sealed in the second capillary 14b by the sealant 20 such as grit glass or the like.

As shown in FIG. 10A, the bottom 32 of the large hollow cylindrical portion 30 of the second ceramic pre-sintered compact 24b is of a curved shape which is concave toward the first ceramic pre-sintered compact 24a to be joined to the second ceramic pre-sintered compact 24b, and the hollow region 28 has a correspondingly curved inner surface. The end face 38a of the plug 38 of the first ceramic pre-sintered compact 24a is a curved surface which is concave toward the second ceramic pre-sintered compact 24b to be joined to first ceramic pre-sintered compact 24a, in complementary relation to the curved surface of the second ceramic pre-sintered compact 24b.

The fifth arc tube 10E can be fabricated by the second manufacturing method shown in FIG. 7 for fabricating the second arc tube 10B. The fifth arc tube 10E offers the same advantages as the second arc tube 10B described above. Preferred modes for materials or the like used in the manufacturing methods according to the embodiments will be described below. The first manufacturing method and the second manufacturing method may collectively be referred to as “manufacturing method”, and the first ceramic compact 22a and the second ceramic compact 22b may collectively be referred to as “ceramic compact”.

### (Ceramic Compact)

According to the above manufacturing method, ceramic compacts are prepared. There are known various methods for manufacturing ceramic compacts, and ceramic compacts can easily be manufactured by those known methods. For example, a ceramic compact may be prepared by a gel casting process. According to the gel casting process, a forming slurry including an inorganic powder and organic compounds is poured into a casting mold, and then solidified by a chemical reaction between the organic compounds, e.g., a chemical reaction between a dispersion medium and a gellant or between gellants, after which the solidified mass is removed from the casting mold. The forming slurry may include a raw powder, a dispersion medium, and gellant, and may also include a dispersant and a catalyst for adjusting viscosity and a solidifying reaction. These various components will be described below.

### (Raw Powder)

A ceramic powder included in the ceramic compact may be of alumina, aluminum nitride, zirconia, YAG, or a mixture of two or more of these materials. A sintering additive for improving sinterability and various properties may be magnesium oxide, but should preferably be ZrO₂, Y₂O₃, La₂O₃, or Sc₂O₃.

### (Dispersion Medium)

A reactive dispersion medium should preferably be used. For example, an organic dispersion medium having a reactive functional group should preferably be used. An organic dispersion medium having a reactive functional group should preferably satisfy two conditions, i.e., it is a liquid substance for chemically bonding with a gellant to be described later, i.e., for solidifying a forming slurry, and a liquid substance for producing a highly flowable forming slurry that can easily be poured into a casting mold. In order to chemically bond with a gellant and solidify a forming slurry, a dispersion medium should preferably have in its molecules a reactive functional group, i.e., a functional group capable of forming a chemical bond with a gellant, such as a hydroxyl group, a carboxyl group, or an amino group.

In order to produce a highly flowable forming slurry that can easily be poured into a casting mold, it is preferable to use an organic dispersion medium whose viscosity is as low as possible, in particular, a substance having a viscosity of 20 cps or lower at a temperature of 20° C.

It is effective to use polyalcohol or polybasic acid for increasing mechanical strength insofar as it does not make the forming slurry unduly viscous.

### (Gellant)

A gellant reacts with a reactive functional group contained in the dispersion medium to cause a solidifying reaction, and is disclosed in International Publication No. WO 2002/085590, page 21 to page 22, line 9. A gellant which is illustrated below may also be used.

In order to join ceramic compacts while keeping their groove configurations, it is desirable that the reactive functional group of a gellant be able to achieve a mechanical strength without deformations under the load applied when the ceramic compacts are joined after the solidifying reaction. In view of this, it is preferable to select a gellant having an isocyanate group (—N═C═O) and/or an isothiocyanate group (—N═C═S) which is highly resistant to solvents after the solidifying reaction and which is highly reactive with a reactive dispersant.

A forming slurry for producing a ceramic compact is disclosed in Japanese Laid-Open Patent Publication No. 2008-044344 and International Publication No. WO 2002/085590. For example, a forming slurry may also be prepared as follows: A raw powder is dispersed in a dispersion medium to produce a forming slurry, to which a gellant is subsequently added. Alternatively, a raw powder and a gellant are simultaneously added to a dispersion medium to produce a forming slurry.

### (Production of a Sintered Body, i.e., a Ceramic Tube)

Two or more ceramic compacts that have been prepared, or ceramic pre-sintered compacts produced by pre-sintering ceramic compacts in the air are assembled together with a first electrode, using a jig mentioned above or the like, thereby fabricating an assembled body or a joined body. Thereafter, the assembled body or the joined body is sintered into a sintered body. Before the assembled body or the joined body is sintered, it may be degreased or pre-sintered.

### (Electrode)

Electrodes which are shrink-fitted or sealed in a ceramic tube may be made of any of various known materials. For example, from the standpoint of melting point and thermal expansion, an electrode shank and a coil should preferably be made of W (tungsten), and a lead should preferably be made of W, Mo (molybdenum), Nb (niobium), Ir (iridium), Re (rhenium), Ru (ruthenium), or the like.

### (Joining Slurry)

A joining slurry is used to join ceramic pre-sintered compacts into a joined body. The joining slurry should preferably be a non-self-curable slurry which is not solidified by a chemical reaction. The joining slurry may include a raw powder which can be used in the forming slurry described above, an unreactive dispersion medium, and any of various binders such as polyvinyl acetal resin, ethyl cellulose, or the like. The joining slurry may also include a dispersant such as DOP (dioctyl phthalate, or Bis(2-ethylhexyl)phthalate) or the like, and an organic solvent such as acetone, isopropanol, or the like for adjusting viscosity at the time materials are mixed.

The joining slurry may be produced by mixing a raw powder, a solvent, and a binder according to a process of manufacturing a normal ceramic paste or slurry which uses a triroll mill, a pot mill, or the like. A dispersant and an organic solvent may be mixed with each other. Specifically, butyl carbitol, butyl carbitol acetate, and terpineol may be used.

### FIRST EXAMPLES

Arc tubes fabricated according to Inventive Example 1, Inventive Example 2, and Comparative Example 1 were measured for cracks and leakages from the light emitting bodies. The arc tubes were confirmed for variations of the distal end position of the first electrode, i.e., variations of the distance from the ceramic wall surface to the distal end of the first electrode.

### INVENTIVE EXAMPLE 1

Ten arc tubes (first arc tube 10A) shown in FIG. 1 were fabricated by the first manufacturing method shown in FIG. 3. The first capillary 14a of the first ceramic tube 16A had an inside diameter of 0.5 mm and the second capillary 14b thereof had an inside diameter of 0.8 mm.

A forming slurry for fabricating the first ceramic compact 22a and the second ceramic compact 22b (see FIGS. 4A and 4B) was prepared as follows: 100 parts by weight of an alumina powder and 0.025 parts by weight of magnesia as a raw powder, 30 parts by weight of polybasic acid ester as a dispersion medium, 4 parts by weight of an MDI resin as a gellant, 2 parts by weight of a dispersant, and 0.2 parts by weight of triethylamine as a catalyst were mixed into a forming slurry.

The forming slurry was poured into a first casting mold and a second casting mold, both made of aluminum alloy, at the room temperature, and was left to stand at the room temperature for 1 hour. After the forming slurry was solidified, it was removed from the first and second casting molds. The solidified forming slurry was then left to stand at the room temperature for 2 hours and then at 90° C. for 2 hours, producing ten first ceramic compacts 22a and ten second ceramic compacts 22b.

Each of the first ceramic compacts 22a was pre-sintered at 1000° C. in the atmosphere to produce a first ceramic pre-sintered compact 24a, and each of the second ceramic compacts 22b was pre-sintered at 1200° C. in the atmosphere to produce a second ceramic pre-sintered compact 24b. Thereafter, using the jig 54 shown in FIG. 2A, the second ceramic pre-sintered compact 24b, the first ceramic pre-sintered compact 24a, and the first electrode 18a were successively assembled into a first assembled body 50A, which was then sintered at 1800° C. in an atmosphere of hydrogen and nitrogen at a ratio of 3:1, thus made densified and light-permeable. The outside diameter of the first electrode 18a was in the range from 0.505 to 0.52 mm so as to be 1.01 to 1.04 times the inside diameter of the first capillary 14a. The first coil 42a on the distal end of the first electrode 18a had a diameter of 0.7 mm. As a result, there was obtained a sintered body (first ceramic tube 16A) from the first assembled body 50A, wherein the light emitting body 12 had an outside diameter of 11 mm, the first capillary 14a and the second capillary 14b had an axial length of 17 mm, and the first electrode 18a was shrink-fitted in the first capillary 14a. Thereafter, the second electrode 18b was sealed in the second capillary 14b by frit glass. In this manner, ten arc tubes (first arc tubes 10A) according to Inventive Example 1 were fabricated. The second electrode 18b had an outside diameter of 0.72 mm so that it could be inserted smoothly into the second capillary 14b.

No crack and no deformation were recognized on the ten arc tubes. When each of the arc tubes was evaluated for thermal shock resistance according to a water quenching process, it suffered no crack even at 150° C. and exhibited the same level of thermal shock resistance as an identically shaped ceramic tube which was free of the first electrode 18a and the second electrode 18b. After the thermal shock resistance evaluation, the arc tubes were measured for a leakage from the light emitting body by a He leakage measuring machine. The leakage from the light emitting body of any of the arc tubes was 1×10⁻⁸ atm·cc/sec or smaller. When variations of the distance from the ceramic wall surface 12a to the distal end of the first electrode 18a of each of the ten arc tubes were evaluated, the difference between maximum and minimum distances was 0.10 mm. When the displacement of the first electrode 18a from the central axis of each of the arc tubes was measured, it was 0.01 mm or smaller.

### INVENTIVE EXAMPLE 2

Ten sintered bodies (second ceramic tubes 16B) shown in FIG. 5 were fabricated by the second manufacturing method shown in FIG. 7. The inside diameter of the first capillary 14a was smaller than the inside diameter of the second capillary 14b.

Ten first ceramic compacts 22a and ten second ceramic compacts 22b (see FIGS. 4A and 4B) were fabricated in the same manner as with Inventive Example 1.

Thereafter, each of the first ceramic compacts 22a was pre-sintered at 1200° C. in the atmosphere to produce a first ceramic pre-sintered compact 24a, and each of the second ceramic compacts 22b was pre-sintered at 1000° C. in the atmosphere to produce a second ceramic pre-sintered compact 24b. Thereafter, using the jig 54 shown in FIG. 6A, the first ceramic pre-sintered compact 24a, the first electrode 18a, and the second ceramic pre-sintered compact 24b were successively assembled into a second assembled body 50B, which was then sintered at 1800° C. in an atmosphere of hydrogen and nitrogen at a ratio of 3:1, thus made densified and light-permeable. As a result, there was obtained a sintered body (second ceramic tube 16B) from the second assembled body 50B, wherein the light emitting body 12 had an outside diameter of 11 mm, the first capillary 14a and the second capillary 14b had an axial length of 17 mm, and the first electrode 18a was shrink-fitted in the first capillary 14a. Thereafter, the second electrode 18b was sealed in the second capillary 14b by frit glass. In this manner, ten arc tubes (second arc tubes 10B) according to Inventive Example 2 were fabricated.

No crack and no deformation were recognized on the ten arc tubes. When each of the arc tubes was evaluated for thermal shock resistance according to a water quenching process, it suffered no crack even at 150° C. and exhibited the same level of thermal shock resistance as an identically shaped ceramic tube which was free of the first electrode 18a and the second electrode 18b. After the thermal shock resistance evaluation, the arc tubes were measured for a leakage from the light emitting body by a He leakage measuring machine. The leakage from the light emitting body of any of the arc tubes was 1×10⁻⁸ atm·cc/sec or smaller. When variations of the distance from the ceramic wall surface 12a to the distal end of the first electrode 18a of each of the ten arc tubes were evaluated, the difference between maximum and minimum distances was 0.05 mm. When the distance between the first electrode 18a and the central axis of each of the arc tubes was measured for a variation from the designed value, the variation was 0.01 mm or smaller.

### COMPARATIVE EXAMPLE 1

Ten arc tubes, which were similar to the arc tube shown in FIG. 1, were fabricated by the first manufacturing method shown in FIG. 3. The first capillary 14a and the second capillary 14b had an inside diameter of 0.8 mm.

Ten first ceramic compacts 22a and ten second ceramic compacts 22b were fabricated in the same manner as with Inventive Example 1.

Thereafter, each of the first ceramic compacts 22a was pre-sintered at 1000° C. in the atmosphere to produce a first ceramic pre-sintered compact 24a, and each of the second ceramic compacts 22b was pre-sintered at 1200° C. in the atmosphere to produce a second ceramic pre-sintered compact 24b. Thereafter, using the jig 54 shown in FIG. 2A, the first ceramic pre-sintered compact 24a and the second ceramic pre-sintered compact 24b were successively assembled into an assembled body, which was then sintered at 1800° C. in an atmosphere of hydrogen and nitrogen at a ratio of 3:1, thus made densified and light-permeable. As a result, there was obtained a sintered body (ceramic tube) from the assembled body, wherein the light emitting body 12 had an outside diameter of 11 mm, the first capillary 14a and the second capillary 14b had an axial length of 17 mm, and no electrodes were inserted in the first capillary 14a and the second capillary 14b. Thereafter, the first electrode 18a and the second electrode 18b were sealed in the first capillary 14a and the second capillary 14b, respectively, by frit glass. In this manner, ten arc tubes according to Comparative Example 1 were fabricated.

No crack and no deformation were recognized on the ten arc tubes. When each of the arc tubes was evaluated for thermal shock resistance according to a water quenching process, it suffered a crack at a sealed portion by the glass frit in the first capillary 14a at 150° C. After the thermal shock resistance evaluation, the arc tubes were measured for a leakage by a He leakage measuring machine. Of the ten sintered bodies, two arc tubes caused a leakage. When variations of the distance from the ceramic wall surface 12a to the distal end of the first electrode 18a of each of the ten arc tubes were evaluated, the difference between maximum and minimum distances was 0.10 mm. When the displacement of the first electrode 18a from the central axis of each of the arc tubes was measured, it was in the range from 0.03 mm to 0.04 mm.

### SECOND EXAMPLES

Arc tubes fabricated according to the first manufacturing method shown in FIG. 3 were confirmed for cracks and deformations (skewing) of the distal ends of the first electrodes at different diameters of the first leads 44a (shrink-fitted) of the first electrodes 18a.

### INVENTIVE EXAMPLE 3

Ten arc tubes (first arc tubes 10A) shown in FIG. 1 were fabricated in the same manner as with Inventive Example 1 described above according to the first manufacturing method shown in FIG. 3, except that the first leads 44a (shrink-fitted) of the first electrodes 18a had a diameter of 0.18 mm.

### INVENTIVE EXAMPLE 4

Ten arc tubes (first arc tubes 10A) shown in FIG. 1 were fabricated in the same manner as with Inventive Example 1 described above according to the first manufacturing method shown in FIG. 3, except that the first leads 44a of the first electrodes 18a had a diameter of 0.50 mm.

### REFERENCE EXAMPLE 1

Ten arc tubes (first arc tubes 10A) shown in FIG. 1 were fabricated in the same manner as with Inventive Example 1 described above according to the first manufacturing method shown in FIG. 3, except that the first leads 44a of the first electrodes 18a had a diameter of 0.15 mm.

### REFERENCE EXAMPLE 2

Ten arc tubes (first arc tubes 10A) shown in FIG. 1 were fabricated in the same manner as with Inventive Example 1 described above according to the first manufacturing method shown in FIG. 3, except that the first leads 44a of the first electrodes 18a had a diameter of 0.60 mm.

### <Evaluation>

The evaluation was performed as follows:

### (Number of Cracks of the First Capillary)

Each of the arc tubes was inspected to determine whether cracks were developed in the first capillary, and the number of arc tubes wherein cracks were developed, out of the ten arc tubes according to each of Reference Examples 1, 2 and Inventive Examples 3, 4.

### (Deformation of Distal End of Electrode)

Each of the arc tubes was inspected to determine whether the axis of the distal end portion of the first electrode is skewed with respect to the axis of the first lead 44a (shrink-fitted portion) or not, i.e., whether the distal end of the electrode is deformed or not. The number of arc tubes wherein the distal end of the electrode is deformed, among the ten arc tubes was confirmed for each of Reference Examples 1, 2 and Inventive Examples 3, 4.

### (Evaluation Results)

The evaluation results are shown in Table 1.

TABLE 1

| | Diameter of | Number of | Deformation |
|---|---|---|---|
| | shrink-fitted | cracks of | (skewing) of |
| | portion of | first | distal end of |
| | first electrode | capillary | electrode |
| Reference | 0.15 mm | 0/10 | 8/10 |
| Example 1 | | | |
| Inventive | 0.18 mm | 0/10 | 0/10 |
| Example 3 | | | |
| Inventive | 0.50 mm | 0/10 | 0/10 |
| Example 4 | | | |
| Reference | 0.60 mm | 8/10 | 0/10 |
| Example 2 | | | |

It can be seen from the results shown in Table 1 that the diameter of the shrink-fitted portion of the first electrode 18a should preferably be in the range from 0.18 to 0.50 mm. The same results were obtained when arc tubes were fabricated according to the second manufacturing method shown in FIG. 7.

### THIRD EXAMPLES

Arc tubes fabricated according to the first manufacturing method shown in FIG. 3 were confirmed for effective lamp times and lamp efficiencies at different ratios of the diameter of the distal end portion of the first electrode 18a to the inside diameter of the first capillary 14a.

### INVENTIVE EXAMPLE 5

Ten arc tubes (first arc tubes 10A) shown in FIG. 1 were fabricated in the same manner as with Inventive Example 1 described above according to the first manufacturing method shown in FIG. 3, except that the ratio the diameter of the distal end portion of the first electrode 18a to the inside diameter of the first capillary 14a was 1.2.

### INVENTIVE EXAMPLE 6

Ten arc tubes (first arc tubes 10A) shown in FIG. 1 were fabricated in the same manner as with Inventive Example 1 described above according to the first manufacturing method shown in FIG. 3, except that the ratio the diameter of the distal end portion of the first electrode 18a to the inside diameter of the first capillary 14a was 4.

### REFERENCE EXAMPLE 3

Ten arc tubes (first arc tubes 10A) shown in FIG. 1 were fabricated in the same manner as with Inventive Example 1 described above according to the first manufacturing method shown in FIG. 3, except that the ratio the diameter of the distal end portion of the first electrode 18a to the inside diameter of the first capillary 14a was 1.1.

### REFERENCE EXAMPLE 4

Ten arc tubes (first arc tubes 10A) shown in FIG. 1 were fabricated in the same manner as with Inventive Example 1 described above according to the first manufacturing method shown in FIG. 3, except that the ratio the diameter of the distal end portion of the first electrode 18a to the inside diameter of the first capillary 14a was 5.

### <Evaluation>

The evaluation was performed as follows:

### (Effective Lamp Time)

A continuous energization test was conducted on each of the arc tubes to measure a period of time (effective time during which the arc tube functions as a lamp) from the start of energization to the time when the brightness dropped to 80% of the brightness at the start of energization.

The ratios of the effective lamp times of Inventive Example 6 and Reference Examples 3, 4 to the effective lamp time h (hour) of Inventive Example 5 were checked.

### (Lamp Efficiency)

Lamp efficiencies of Inventive Example 6 and Reference Examples 3, 4 were indicated as relative values with respect to the lamp efficiency 100 of Inventive Example 5.

### (Evaluation Results)

The evaluation results are shown in Table 2.

TABLE 2

| | Ratio of diameter of | | |
|---|---|---|---|
| | distal end portion | | Lamp |
| | of first electrode | | efficiency |
| | to inside diameter | Effective lamp | (relative |
| | of first capillary | time | value) |
| Reference | 1.1 | 0.8 h | 100 |
| Example 3 | | | |
| Inventive | 1.2 | h | 100 |
| Example 5 | | | |
| Inventive | 4 | 1.1 h | 95 |
| Example 6 | | | |
| Reference | 5 | 1.1 h | 80 |
| Example 4 | | | |

It can be seen from the results shown in Table 2 that the ratio of the diameter of the distal end portion of the first electrode 18a to the inside diameter of the first capillary 14a should preferably be in the range from 1.2 to 4. The same results were obtained when arc tubes were fabricated according to the second manufacturing method shown in FIG. 7.

### FOURTH EXAMPLES

Arc tubes, which are of the type energized by a DC power supply and fabricated according to the first manufacturing method shown in FIG. 3, were confirmed for cracks of the cathode (first capillary) and lamp efficiencies at different ratios of the diameter of the portion of the first electrode 18a which is sealed in the first capillary 14a to the diameter of the portion of the second electrode 18b which is sealed in the second capillary 14b, (hereinafter referred to as ratios of the diameter of the first electrode 18a to the diameter of the second electrode 18b).

### INVENTIVE EXAMPLE 7

Ten arc tubes (first arc tubes 10A) shown in FIG. 1 were fabricated in the same manner as with Inventive Example 1 described above according to the first manufacturing method shown in FIG. 3, except that the ratio of the diameter of the first electrode 18a to the diameter of the second electrode 18b was 0.9.

### INVENTIVE EXAMPLE 8

Ten arc tubes (first arc tubes 10A) shown in FIG. 1 were fabricated in the same manner as with Inventive Example 1 described above according to the first manufacturing method shown in FIG. 3, except that the ratio of the diameter of the first electrode 18a to the diameter of the second electrode 18b was 0.2.

### REFERENCE EXAMPLE 5

Ten arc tubes (first arc tubes 10A) shown in FIG. 1 were fabricated in the same manner as with Inventive Example 1 described above according to the first manufacturing method shown in FIG. 3, except that the ratio of the diameter of the first electrode 18a to the diameter of the second electrode 18b was 1.0.

### REFERENCE EXAMPLE 6

Ten arc tubes (first arc tubes 10A) shown in FIG. 1 were fabricated in the same manner as with Inventive Example 1 described above according to the first manufacturing method shown in FIG. 3, except that the ratio of the diameter of the first electrode 18a to the diameter of the second electrode 18b was 0.1.

### <Evaluation>

The evaluation was performed as follows:

### (Number of Cracks of the Cathode)

Each of the arc tubes was inspected to determine whether cracks were developed in the cathode (first capillary), and the number of arc tubes wherein cracks were developed, out of the ten arc tubes according to each of Reference Examples 5, 6 and Inventive Examples 7, 8.

### (Lamp Efficiency)

Lamp efficiencies of Reference Examples 5, 6 and Inventive Examples 7, 8 were indicated as relative values with respect to the lamp efficiency 100 of Inventive Example 7.

### (Evaluation Results)

The evaluation results are shown in Table 3.

TABLE 3

| | Ratio of diameter | | Lamp |
|---|---|---|---|
| | of first electrode | Number of | efficiency |
| | to diameter of | cracks of | (relative |
| | second electrode | cathode | value) |
| Reference | 1.0 | 5/10 | 90 |
| Example 5 | | | |
| Inventive | 0.9 | 0/10 | 100 |
| Example 7 | | | |
| Inventive | 0.2 | 0/10 | 100 |
| Example 8 | | | |
| Reference | 0.1 | 0/10 | 80 |
| Example 6 | | | |

It can be seen from the results shown in Table 3 that the ratio the diameter of the first electrode 18a to the diameter of the second electrode 18b should preferably be in the range from 0,2 to 0.9. The same results were obtained when arc tubes were fabricated according to the second manufacturing method shown in FIG. 7.

Although certain preferred embodiments of the present invention have been shown and described in detail, it should be understood that various changes and modifications may be made therein without departing from the scope of the appended claims.

What is claimed is:

1. An arc tube comprising:
a light emitting body for light therein; and
a ceramic tube having a first capillary and a second capillary integral with respective opposite sides of the light emitting body;
a first electrode inserted and sealed in the first capillary; and
a second electrode inserted and sealed in the second capillary;
wherein the first electrode is sealed in the first capillary by shrink fitting.

2. The arc tube according to claim 1, wherein a portion of the first electrode which is shrink-fitted in the first capillary has a diameter in the range from 0.18 mm to 0.5 mm.

3. The arc tube according to claim 1, wherein the first electrode includes a distal end portion having a diameter in the range from 0.22 mm to 2.0 mm, and in the range from 1.2 times to 4 times an inside diameter of the first capillary.

4. The arc tube according to claim 1, wherein the first electrode serves as a cathode electrode, the second electrode as an anode electrode, and a portion of the first electrode which is sealed in the first capillary has a diameter in the range from 0.2 times to 0.9 times a diameter of a portion of the second electrode which is sealed in the second capillary.

5. The arc tube according to claim 1, wherein the ceramic tube is constructed by assembling and sintering a first member integral with a first small hollow cylindrical portion which will subsequently become the first capillary, a second member integral with a second small hollow cylindrical portion which will subsequently become the second capillary, and the first electrode.

6. The arc tube according to claim 5, wherein the first electrode has a positioner for positioning a distal end position of the first electrode in the light emitting body by contacting an end of the first capillary.

7. The arc tube according to claim 5, wherein the first electrode has a positioner for positioning a distal end position of the first electrode in the light emitting body by contacting an inner surface of the first member which faces the light emitting body.

8. The arc tube according to claim 5, wherein the first member includes a hollow cylindrical portion having a hollow region therein with an opening defined in one end thereof, and the first small hollow cylindrical portion which is integral with a portion of the hollow cylindrical portion which is opposite to the opening; and
the second member includes a plug closing the opening in the hollow cylindrical portion and the second small hollow cylindrical portion which is integral with a central portion of the plug.

9. The arc tube according to claim 5, wherein the second member includes a hollow cylindrical portion having a hollow region therein with an opening defined in one end thereof, and the second small hollow cylindrical portion which is integral with a portion of the hollow cylindrical portion which is opposite to the opening; and
the first member includes a plug closing the opening in the hollow cylindrical portion and the first small hollow cylindrical portion which is integral with a central portion of the plug.

10. The arc tube according to claim 5, wherein the first member includes a first curved portion having a hollow region therein with a first opening defined in one end thereof, and the first small hollow cylindrical portion which is integral with a portion of the first curved portion which is opposite to the first opening;
the second member includes a second curved portion having a hollow region therein with a second opening defined in one end thereof, and the second small hollow cylindrical portion which is integral with a portion of the second curved portion which is opposite to the second opening; and
the ceramic tube is constructed by joining the first member and the second member such that the first opening and the second opening face each other.

11. A method of manufacturing an arc tube including a light emitting body for light therein, a ceramic tube having a first capillary and a second capillary integral with respective opposite sides of the light emitting body, a first electrode inserted and sealed in the first capillary, and a second electrode inserted and sealed in the second capillary, comprising:
a first member fabricating step of pre-sintering a first ceramic compact into a first member having a first small hollow cylindrical portion which will subsequently become the first capillary and a first through hole defined axially in the first small hollow cylindrical portion;
a second member fabricating step of pre-sintering a second ceramic compact into a second member having a second small hollow cylindrical portion which will subsequently become the second capillary and a second through hole defined axially in the second small hollow cylindrical portion;
an assembling step of assembling the first member, the second member, and the first electrode into an assembled body;
a ceramic tube fabricating step of sintering the assembled body into the ceramic tube having the light emitting body, the first capillary, and the second capillary, and sealing the first electrode in the first capillary by shrink fitting;
a step of introducing a light-emitting substance through the second capillary into the light emitting body of the ceramic tube; and
an electrode sealing step of inserting and sealing the second electrode in the second capillary.

12. The method according to claim 11, wherein the first member fabricating step pre-sinters the first ceramic compact into the first member at a first temperature;
the second member fabricating step pre-sinters the second ceramic compact into the second member at a second temperature which is higher than the first temperature; and
the ceramic tube fabricating step sinters the assembled body into the ceramic tube at a third temperature which is higher than the second temperature.

13. The method according to claim 12, wherein the first electrode includes a distal end portion having a diameter smaller than a diameter of the first through hole and a positioner on a rear end portion thereof for determining a distal end position of the first electrode; and
in the assembling step, the second member and the first member are assembled such that the first member and the second member face each other, and thereafter the first electrode is inserted into the first through hole of the first member until the positioner contacts a rear end of the first small hollow cylindrical portion.

14. The method according to claim 11, wherein the first member fabricating step pre-sinters the first ceramic compact into the first member at a fourth temperature;
the second member fabricating step pre-sinters the second ceramic compact into the second member at a fifth temperature which is lower than the fourth temperature; and
the ceramic tube fabricating step sinters the assembled body into the ceramic tube at a third temperature which is higher than the fourth temperature.

15. The method according to claim 14, wherein the first electrode includes a distal end portion having a diameter larger than a diameter of the first through hole and a positioner on a distal end part thereof for determining a distal end position of the first electrode; and
in the assembling step, the first electrode is inserted into the first through hole of the first member until the positioner contacts an end face which is to face the second member, and then the first member and the second member are assembled such that the first member and the second member face each other.
